(19) United States
(12) Patent Application Publication
(10) Pub. No.: US 2021/0200589 A1
(43) Pub. Date: Jul. 1, 2021

(54) Resource Management for Web Browser Based Applications

(71) Applicant: McAfee, LLC, Santa Clara, CA (US)

(72) Inventors: Shashank Jain, Bangalore (IN); Raja Sinha, Bangalore (IN); Dattatraya Kulkarni, Bangalore (IN)

(73) Assignee: McAfee, LLC, Santa Clara, CA (US)

(21) Appl. No.: 16/729,936

(22) Filed: Dec. 30, 2019

(51) Int. Cl. G06F 9/50; G06F 16/958; G06F 16/957

(52) U.S. Cl. CPC G06F 9/505; G06F 16/957; G06F 16/958; G06F 9/5088

(57) ABSTRACT

There is disclosed in one example a computing apparatus, including: a hardware platform including a processor and a memory; an operating system including a priority architecture; a multi-process web browser; and a browser optimizer agent including instructions encoded within the memory to instruct the processor to: inspect a process of the web browser; determine from the inspection that resource utilization for the process can be improved, and adjust resource priority via the operating system to improve resource utilization for the process.

### FIELD OF THE SPECIFICATION

This application relates in general to user space computing, and more particularly, though not exclusively, to a system and method for providing resource management for web browser based applications.

### BACKGROUND

Users of modern computing devices increasingly demand a high degree of mobility in their applications. As such, web browsers have become important in an ever-expanding array of processing tasks.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram showing selected elements of a security ecosystem.

FIG. 2 is an illustration of process views, in an example taken from the Chrome web browser.

FIG. 3 is an illustration showing Chrome process clutter from the operating system view.

FIG. 4 is a block diagram that can be used to better understand the operation of a browser optimizer agent.

FIG. 5 is a flowchart illustrating a method that may be performed by a browser optimizer agent.

FIG. 6 is a flowchart of a method for deprioritization of processes.

FIG. 7 is a block diagram illustrating selected elements of a hardware platform.

FIG. 8 is a block diagram illustrating further selected elements of a hardware platform.

FIG. 9 is a block diagram of selected elements of a system-on-a-chip (SoC).

FIG. 10 is a block diagram of selected elements of a processor.

### SUMMARY

In an example, there is disclosed a computing apparatus, comprising: a hardware platform comprising a processor and a memory; an operating system comprising a priority architecture; a multi-process web browser; and a browser optimizer agent comprising instructions encoded within the memory to instruct the processor to: inspect a process of the web browser; determine from the inspection that resource utilization for the process can be improved, and adjust resource priority via the operating system to improve resource utilization for the process.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

As computer usage moves increasingly toward software as a service (SaaS), and as more of what users do on their computers takes place online, the web browser plays an increasingly central role in managing interactions with the computer. In some cases, such as in the case of Chrome OS, the entire operating system (OS) is essentially based on a web browser, and most computing tasks are expected to be performed online.

Even in more traditional desktop setups, such as Microsoft Windows, Apple OS X, and various flavors of desktop UNIX and Linux, where native application execution is supported, many users will still perform many tasks online.

For example, office applications that traditionally belonged to the desktop can now increasingly be accessed online, such as via Microsoft Office 365 and Google Docs, by way of illustrative and nonlimiting example. Communication can be accomplished online, such as via web-based chat and video conference software. Entertainment may take place online, as users use the browser to access streaming audio and video services. And while casual games have long belonged to the browser, increasingly even more resource intensive games, such as those that require graphics processing unit (GPU) rendering, are also happening online.

Thus, even on some traditional operating systems, the browser behaves increasingly as the platform for launching and managing applications, including many daily activities such as social activities, banking, gaming, entertainment, finance, office and enterprise resources, and business-to-business communications.

Essentially, the modern browser has become an integral part of most operating systems. Browsers support multiple tabs spawned over multiple processes, manage their own resources, manage their own input/output (I/O), and even have some ability to take care of process priorities. The tab-to-browser relationship has essentially become very similar to the application-to-OS relationship. In other words, with the browser as a platform, the tabs become applications.

Modern browsers have evolved from the early days of a single window rendering a static webpage to a contemporary scripted multimedia platform with tens of processes and tabs, and comprehensive capabilities. Each tab may have different compute resources from each other tab. For example, a simple rendering of a text-heavy news site will have different resource requirements from those of a video streaming site, which may have different resource requirements from a casual gaming site, which may have different resource requirements from an intensive gaming site. To meet this demand, browser architecture has also evolved over time to manage varying and complex compute requirements across multiple websites. For example, a banking website or a newsreader may be light in compute resource requirements, and require relatively little network bandwidth. A video streaming webpage may have relatively higher network and central processor unit (CPU) requirements, but may have little to no GPU requirement. A casual gaming website may have little network bandwidth requirement, and a somewhat higher CPU utilization to render the casual game. A more intense gaming website may have heavy network, CPU, and GPU requirements to render compute intensive games.

Even with a fundamental coherency in the architectural and process management philosophy, the browser and the operating system domains remain essentially disconnected. The browser and the operating system remain in separate functional silos, with each having relatively little visibility into the other. Modern browser platforms use multi-process architecture, wherein a new operating system process is spawned for each new web application. This architecture greatly improves system stability and application security by providing a sandboxed environment for the application. Unfortunately, however, this multi-process browser architecture makes it harder for the operating system, because the operating system has no context to inspect what the processes are used for, and how the browser utilizes the spawned processes. Conversely, traditional browsers have very little insight into the operating system outside of what is commonly available to user space applications. To ensure that the browser does not interfere with other important operating system processes, browsers are often very conservative in the resources that they request, and particularly in increasing process privileges.

These limitations can be bridged, however, by overcoming the disconnect between browser context and operating system level resource management. The prioritization rules of existing browser platforms generally do not consider the resource utilization by other processes at the operating system level. For example, browsers often do not have the opportunity to aggressively allocate more resources, even when those resources are available, because the browser does not have visibility into operating system resource demands. Thus, many modern browsers are consistently conservative in setting tab priorities. Some browsers never set a tab or process to high priority, even when other processes are not utilizing the resources, and a large portion of resources are available.

Many browsers also do not provide intelligence in identifying the appropriate resource requirement of a particular uniform resource location (URL), and therefore may fail to bring the resource aware prioritization of resources to the operating system. For example, a process running a content streaming website and another one running a live online gaming website will not have the same resource requirements. However, from the perspective of the operating system, they are both simply browser tabs and browser processes, and the operating system may have little opportunity to aggressively manage priorities for those separate processes. For example, a video streaming website may require more CPU and network bandwidth, while the live online gaming website may require more CPU, GPU, and network resources combined. Without visibility into these processes, the operating system may not have the intelligence to allocate appropriate resources to each process and operating system tab.

Thus, in the absence of cohesive and synergistic cooperation between operating systems and browsers, “tabs as applications” are not optimized for the user experience the same way that a native application would be optimized. Because the optimization techniques employed by the browser are not visible to the operating system, and the browser context is not visible to the operating system, the browser process management effectively operates as a black box from the perspective of the operating system. This deprives the operating system of the ability to provide performance and resource optimization techniques that are traditionally applied at the operating system level for native operating system applications.

This disconnect can be bridged by providing a mechanism to map web-based applications running on browser tabs to operating system level entities. Techniques can then be employed to dynamically make resource aware prioritization decisions and performance decisions based on the tabs' (and browser processes') requirements most relevant to the user's expectations for those tabs.

A multi-process architecture (e.g., one process per instance) is the default mode for many widely-used browsers, such as Google Chrome, Microsoft Edge, Mozilla Firefox, and Apple Safari. A web browser plug-in can be used to identify exact web application and process matching. However, getting that information outside of the browser to the operating system environment is difficult or impossible, because of the blackbox nature of the browser. Furthermore, a browser plug-in does not have the system view of resources, and thus cannot perform system level optimizations.

However, an operating system agent can be provided as a bridge between the operating system and the browser. This agent may be referred to by way of illustration as a browser optimizer agent. The browser optimizer agent of the present specification can be used to bridge the resource utilization gap between the browser and the operating system. This can provide an enhanced user experience. For example, empirical testing of a browser optimizer agent according to the present specification resulted in an approximately 15% increase in resource utilization efficiency for browser-based applications. This has a measurable and perceptible effect on the user experience, and thus enhances the user's operation of and enjoyment of the computer.

A system and method for providing resource management for web browser based applications will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

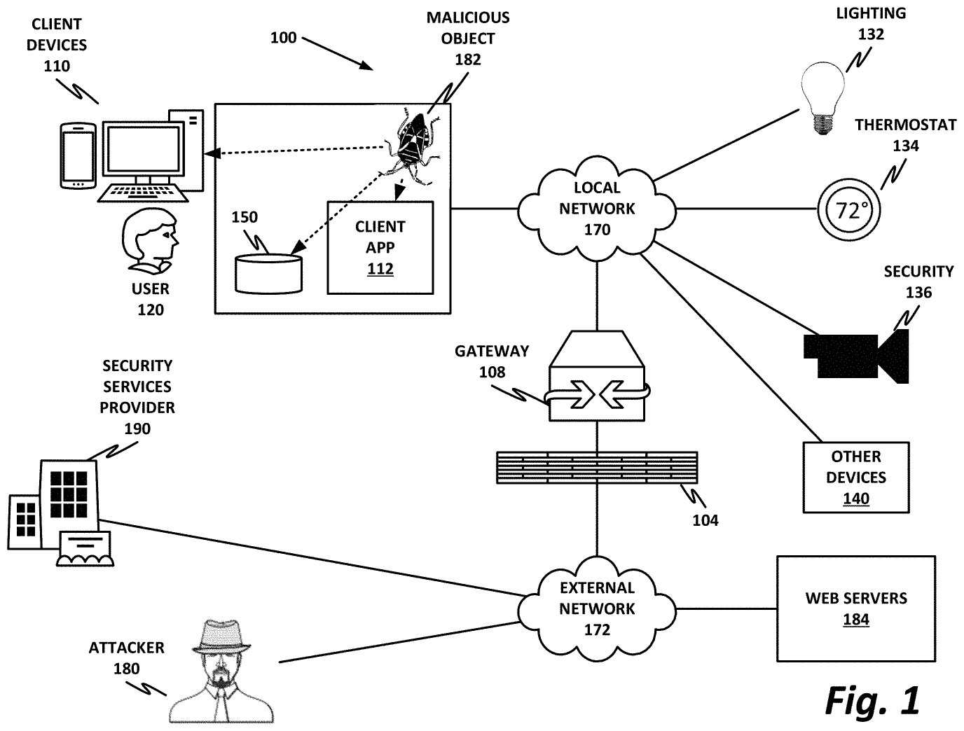

FIG. 1 is a block diagram of a security ecosystem 100. In at least some embodiments, security ecosystem 100 may be configured or adapted to provide the method of resource management for web browser based applications, according to the teachings of the present specification.

In the example of FIG. 1, security ecosystem 100 may be an enterprise, a government entity, a data center, a telecommunications provider, a “smart home” with computers, smart phones, and various internet of things (IoT) devices, or any other suitable ecosystem. Security ecosystem 100 is provided herein as an illustrative and nonlimiting example of a system that may employ, and benefit from, the teachings of the present specification.

Within security ecosystem 100, one or more users 120 operate one or more client devices 110. A single user 120 and single client device 110 are illustrated here for simplicity, but a home or enterprise may have multiple users, each of which may have multiple devices, such as desktop computers, laptop computers, smart phones, tablets, hybrids, or similar.

Client devices 110 may be communicatively coupled to one another and to other network resources via local network 170. Local network 170 may be any suitable network or combination of one or more networks operating on one or more suitable networking protocols, including a local area network, a home network, an intranet, a virtual network, a wide area network, a wireless network, a cellular network, or the internet (optionally accessed via a proxy, virtual machine, or other similar security mechanism) by way of nonlimiting example. Local network 170 may also include one or more servers, firewalls, routers, switches, security appliances, antivirus servers, or other network devices, which may be single-purpose appliances, virtual machines, containers, or functions. Some functions may be provided on client devices 110.

In this illustration, local network 170 is shown as a single network for simplicity, but in some embodiments, local network 170 may include any number of networks, such as one or more intranets connected to the internet. Local network 170 may also provide access to an external network, such as the internet, via external network 172. External network 172 may similarly be any suitable type of network, and may communicatively connect with remote web servers 184. User 120 could communicate with remote web servers 184 via client device 110. Remote web servers 184 could provide a variety of online applications, including, by way of illustrative and nonlimiting example, daily-use applications to facilitate social activities, banking, gaming, entertainment, finance, office and enterprise resources, and business-to-business communications.

Local network 170 may connect to the internet via gateway 108, which may be responsible, among other things, for providing a logical boundary between local network 170 and external network 172. Local network 170 may also provide services such as dynamic host configuration protocol (DHCP), gateway services, router services, and switching services, and may act as a security portal across local boundary 104.

In some embodiments, gateway 108 may be a standalone internet appliance. Such embodiments are popular in cases in which ecosystem 100 includes a home or small business. In other cases, gateway 108 may run as a virtual machine or in another virtualized manner. In larger enterprises that features service function chaining (SFC) or network function virtualization (NFV), gateway 108 may be include one or more service functions and/or virtualized network functions.

Local network 170 may also include a number of discrete IoT devices. For example, local network 170 may include IoT functionality to control lighting 132, thermostats or other environmental controls 134, a security system 136, and any number of other devices 140. Other devices 140 may include, as illustrative and nonlimiting examples, network attached storage (NAS), computers, printers, smart televisions, smart refrigerators, smart vacuum cleaners and other appliances, and network connected vehicles.

Local network 170 may communicate across local boundary 104 with external network 172. Local boundary 104 may represent a physical, logical, or other boundary. External network 172 may include, for example, websites, servers, network protocols, and other network-based services. In one example, an attacker 180 (or other similar malicious or negligent actor) also connects to external network 172. A security services provider 190 may provide services to local network 170, such as security software, security updates, network appliances, or similar. For example, MCAFEE, LLC provides a comprehensive suite of security services that may be used to protect local network 170 and the various devices connected to it.

It may be a goal of users 120 to successfully operate devices on local network 170 without interference from attacker 180. In one example, attacker 180 is a malware author whose goal or purpose is to cause malicious harm or mischief, for example, by injecting malicious object 182 into client device 110. Once malicious object 182 gains access to client device 110, it may try to perform work such as social engineering of user 120, a hardware-based attack on client device 110, modifying storage 150 (or volatile memory), modifying client application 112 (which may be running in memory), or gaining access to local resources. Client application 112 could be, for example, a security agent such as LiveSafe™ by MCAFEE, LLC. The security agent may include a browser optimizer agent that could mediate between a browser and an operating system of computing device 110.

In some embodiments, attacks may be directed at IoT objects. IoT objects can introduce new security challenges, as they may be highly heterogeneous, and in some cases may be designed with minimal or no security considerations. To the extent that these devices have security, it may be added on as an afterthought. Thus, IoT devices may in some cases represent new attack vectors for attacker 180 to leverage against local network 170.

Malicious harm or mischief may take the form of installing root kits or other malware on client devices 110 to tamper with the system, installing spyware or adware to collect personal and commercial data, defacing websites, operating a botnet such as a spam server, or simply to annoy and harass users 120. Thus, one aim of attacker 180 may be to install his malware on one or more client devices 110 or any of the IoT devices described. As used throughout this specification, malicious software (“malware”) includes any object configured to provide unwanted results or do unwanted work. In many cases, malware objects will be executable objects, including, by way of nonlimiting examples, viruses, Trojans, zombies, rootkits, backdoors, worms, spyware, adware, ransomware, dialers, payloads, malicious browser helper objects, tracking cookies, loggers, or similar objects designed to take a potentially-unwanted action, including, by way of nonlimiting example, data destruction, data denial, covert data collection, browser hijacking, network proxy or redirection, covert tracking, data logging, keylogging, excessive or deliberate barriers to removal, contact harvesting, and unauthorized self-propagation. In some cases, malware could also include negligently-developed software that causes such results even without specific intent.

In enterprise contexts, attacker 180 may also want to commit industrial or other espionage, such as stealing classified or proprietary data, stealing identities, or gaining unauthorized access to enterprise resources. Thus, attacker 180's strategy may also include trying to gain physical access to one or more client devices 110 and operating them without authorization, so that an effective security policy may also include provisions for preventing such access.

In another example, a software developer may not explicitly have malicious intent, but may develop software that poses a security risk. For example, a well-known and often-exploited security flaw is the so-called buffer overrun, in which a malicious user is able to enter an overlong string into an input form and thus gain the ability to execute arbitrary instructions or operate with elevated privileges on a computing device. Buffer overruns may be the result, for example, of poor input validation or use of insecure libraries, and in many cases arise in nonobvious contexts. Thus, although not malicious, a developer contributing software to an application repository or programming an IoT device may inadvertently provide attack vectors for attacker 180. Poorly-written applications may also cause inherent problems, such as crashes, data loss, or other undesirable behavior. Because such software may be desirable itself, it may be beneficial for developers to occasionally provide updates or patches that repair vulnerabilities as they become known. However, from a security perspective, these updates and patches are essentially new objects that must themselves be validated.

Local network 170 may contract with or subscribe to a security services provider 190, which may provide security services, updates, antivirus definitions, patches, products, and services. MCAFEE, LLC is a nonlimiting example of such a security services provider that offers comprehensive security and antivirus solutions. In some cases, security services provider 190 may include a threat intelligence capability such as the global threat intelligence (GTI) database provided by MCAFEE, LLC, or similar competing products. Security services provider 190 may update its threat intelligence database by analyzing new candidate malicious objects as they appear on client networks and characterizing them as malicious or benign.

Other security considerations within security ecosystem 100 may include parents' or employers' desire to protect children or employees from undesirable content, such as pornography, adware, spyware, age-inappropriate content, advocacy for certain political, religious, or social movements, or forums for discussing illegal or dangerous activities, by way of nonlimiting example.

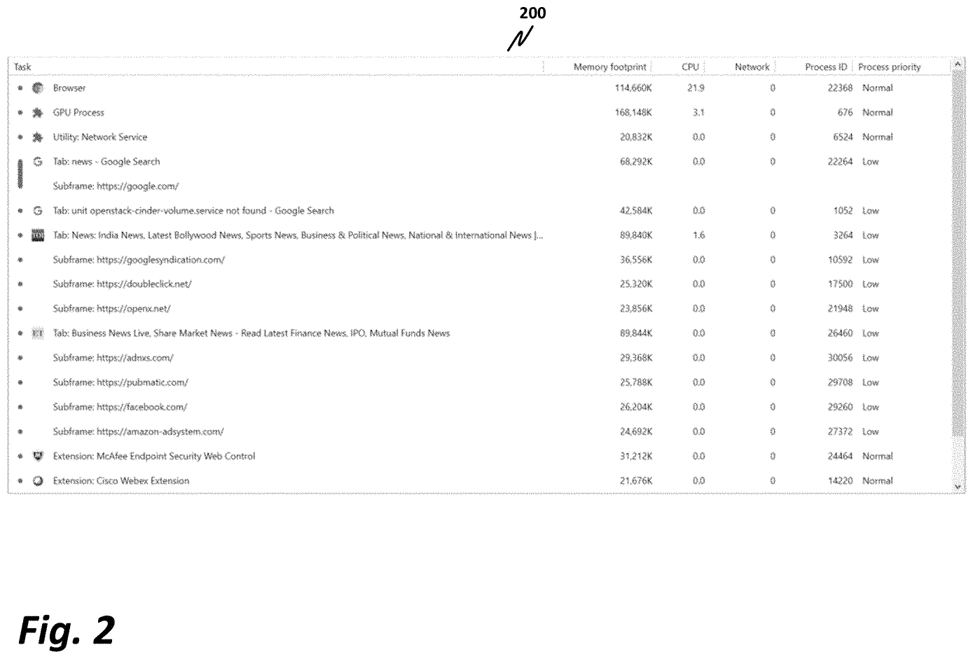

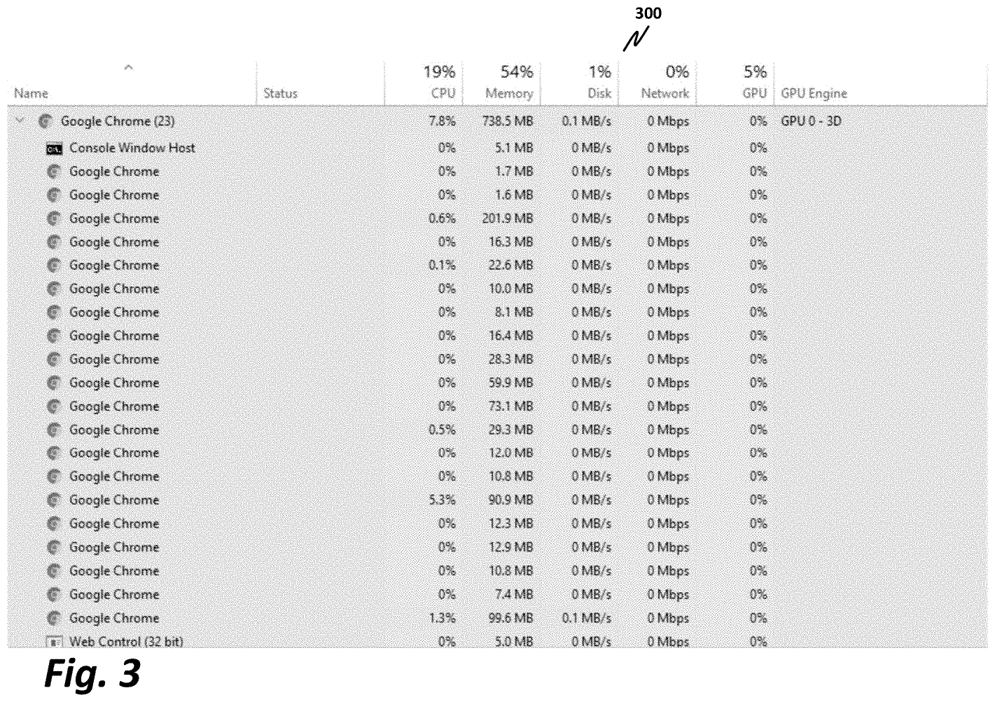

FIGS. 2 and 3 illustrate some aspects of the difficulty of managing web-based applications. FIG. 2 is an illustration of task manager 200 showing process views, in an example taken from the Chrome web browser. This illustration is an example taken from the Chrome web browser, with five tabs open in Chrome's internal task manager. FIG. 3 is an illustration of task manager 300 showing Chrome process clutter from the operating system view. Together, FIGS. 2 and 3 illustrate the browser processes, as viewed from within the browser's own task manager (FIG. 2), and from within the operating system task manager (FIG. 3).

Comparing task manager 200 with task manager 300, it is seen that the operating system view depicts the black box nature of the browser processes. The tab-to-process mapping and its relevance to the user can be lost between the browser and the operating system.

The images above also illustrate some of the clutter issues encountered, in this case when the browser creates just five tabs or web applications.

For multi-process browser platforms like Chromium, using a “one process per instance” model, not only can the clutter be substantial, but there can be substantial disconnect between the requirements to optimize browser resource usage and the operating system's resource optimization model.

The present specification provides novel mechanisms for using the current process priority, the command line parameters, and visited domains to:

Identify the web application (tab), or applications relevant to the user at a given instance. These are mapped to corresponding operating system entities (processes) from outside the browser environment.

Dynamically identify critical resources (e.g., compute, I/O, GPU, network, etc.) for each tab process based on the associated domain.

Optimize the resource allocation for the relevant critical resources required by the process by deprioritizing resource allocation for other noncritical processes.

Advantageously, this can be accomplished without any browser extension. If a browser extension were required, the mechanism may face a barrier to entry, because the user may or may not install the extension.

Empirically, a browser optimizer agent of the present specification was shown to result in an approximate 15% performance improvement in industry-standard benchmark tests, such as WebXpert.

Features of the browser optimizer agent include identifying the web applications (tabs) that are critical to the user at a given instance from outside the browser environment (i.e., from the operating system view).

Another feature is the use of techniques to categorize each tab process, based on the types and combination of types of resource demands. For example, domain xyz1.com may require more GPU and CPU, while domain xyz2.com may require more network and CPU. In some embodiments, this categorization may be done in the cloud, and may be associated with a global cloud database such as GTI by MCAFEE, LLC or similar. This ensures that the identification of resource requirements for different domain names can be optimized across many different clients.

The browser optimizer agent may also include techniques for optimizing critical resources to enhance performance of critical processes, and to provide a better user experience.

The browser optimizer agent may also intelligently distinguish the resource requirements for processes managing critical browser functions such as core browser, document object model (DOM) manager, network manager, renderer, etc.

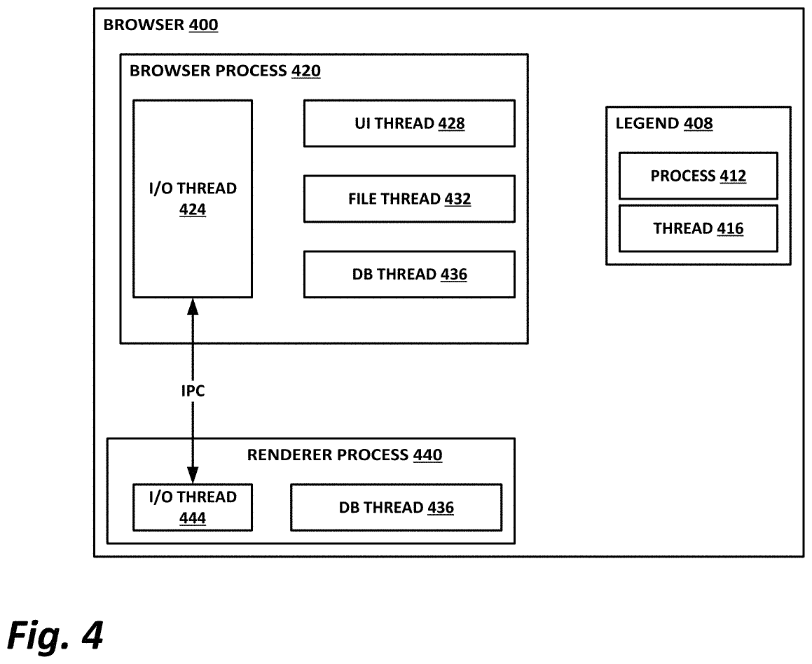

FIG. 4 is a block diagram that can be used to better understand the operation of a browser optimizer agent. The browser optimizer agent provides a novel mechanism to identify browser platform processes that are relevant to the user at a given instance, from outside of the browser environment. The agent can also identify critical resources for the relevant process, and optimize them for optimal user experience.

As illustrated in FIG. 4, a browser 400 includes a browser process 420 and a renderer process 440, by way of illustration. This may be to render a view of a webpage.

Browser 400 includes a separate process for core browser functionalities such as DOM parser and renderer, GPU management, and extensions, besides several other utility processes. At present, there is no known mechanism for browser 400 to convey to the operating system the tabs currently used by the browser and the expected resource usage profile of the tabs. This poses a platform-level challenge to optimize the process for better user experience. The problem becomes even more severe when the browser starts managing the processes (e.g., priority of the processes), because the browser has no system level context, and therefore cannot manage other system resources. Many browsers solve this issue by being extremely conservative in their management of resources, which helps to ensure that the browser does not interfere with critical system processes. However, this may result in a less than optimal browsing experience, because the browser is unable to take full advantage of system resources, even if they are available.

As illustrated in FIG. 4, browser 400 includes browser process 420 and renderer process 440. Browser process 420 includes an I/O thread 424 that communicatively couples to a user interface thread 428, a file thread 432, and a database thread 436. These threads are provided by way of illustrative and nonlimiting example.

Browser 400 provides a legend 408 that maps a process 412 to a thread 416. This enables browser 400 to keep track of processes and threads, and to manage resources appropriately within its abilities.

Browser 400 also includes renderer process 440. Renderer process 440 includes an I/O thread 444, that communicates with I/O thread 424 of browser process 420, via interprocess communication.

In a typical multi-process browser platform such as a Chromium-based browser, when the browser is launched, the main browser process is created first. Later, all active extensions are loaded into separate extension processes, as well. After that, there may be one renderer process spawned per instance of a website visited. As FIG. 4 illustrates, there is interaction between a renderer process 440 and browser process 420. Browser process 420 contains several threads, each with different responsibilities, such as user interaction, operating system calls, I/O handling, and storage handling, by way of illustrative and nonlimiting example. These threads interact with other modules and processes via remote procedure call (RPC), for example. This architecture is good for browser internal process management, but creates a great deal of clutter and makes resource optimization difficult from the point of view of the entire operating system.

This process can be improved by a browser optimizer agent. The browser optimizer agent maps the browser tab process creation events to domain queries. This mapping helps to identify the type of browsing activity for each tab process, and to determine the resource requirements for that tab process. The agent can also determine if the tab process is currently relevant to the user by evaluating if the current process priority is normal. The agent may determine methods to prioritize the resource allocation for the relevant processes, and at the same time, deprioritize nonrelevant or noncritical processes. As discussed above, this may result in process improvements up to approximately 15% in benchmark tests, as applied to an experimental model.

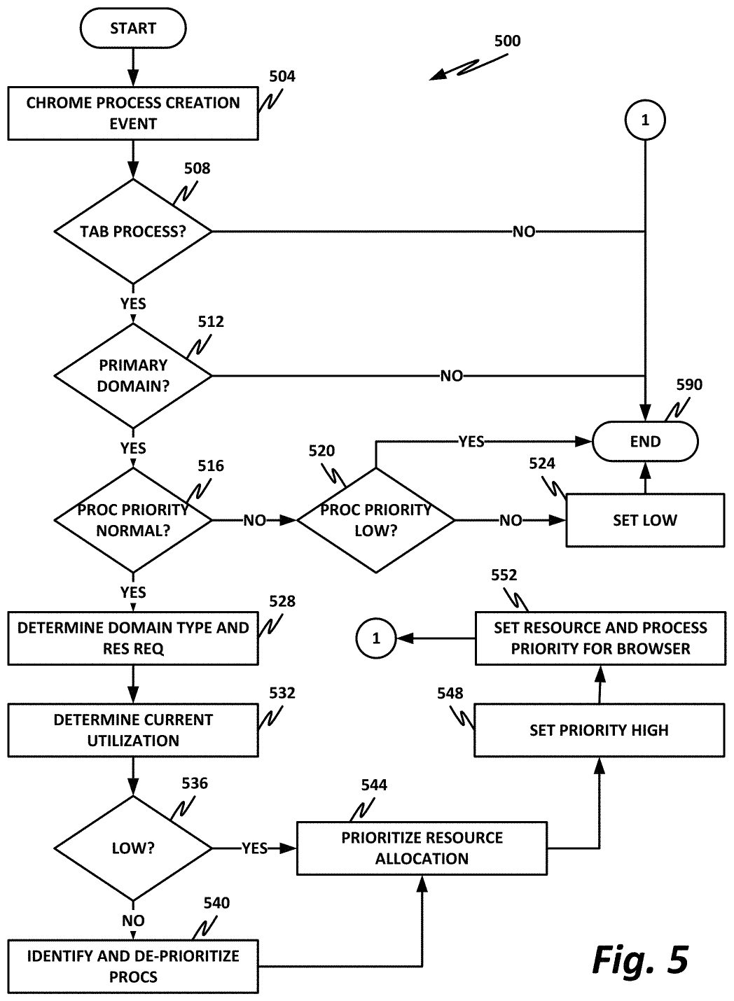

FIG. 5 is a flowchart illustrating a method 500 that may be performed by a browser optimizer agent, as described herein. Method 500 illustrates a number of operations that are provided to illustrate operational features of the browser optimizer agent of the present specification. In appropriate embodiments, some of the operations of method 500 may be omitted, while in other embodiments, additional operations may be inserted. Furthermore, although the operations are illustrated in a particular order to facilitate discussion, this order is not required of any particular embodiment. Rather, the order may be altered as appropriate to certain embodiments.

To facilitate discussion, method 500 will first be described at a relatively high level, and then certain aspects of method 500 will be expanded upon in more detail.

It should also be noted that method 500 is disclosed as an example drawn specifically to the popular Chrome browser, which may also be applicable to Chromium-based browsers. Chrome is a very popular browser in the user segment. The teachings of method 500 may be adapted as necessary to other browsers, such as Mozilla Firefox or Apple Safari, by way of nonlimiting example.

In block 504, the browser optimizer agent first identifies the Chrome process creation event.

In decision block 508, the agent inspects the process to determine whether it is a tab process. If the process is not a tab process, then according to at least some embodiments, no optimization is required, and in block 590, the method is done. Returning to block 508, if the process being inspected is a tab process, then in decision block 512, the agent determines whether the domain associated with the process is a “primary domain.” The designation of a domain as a primary domain will be described in greater detail below.

If the domain is not a primary domain, then in some embodiments, there is no need to optimize, and in block 590, the method is done.

Returning to decision block 512, if the domain is a primary domain, then there may be a need to optimize the process, so control flows to block 516. In block 516, the agent determines the current process priority.

If the process priority is not normal, then in decision block 520, the agent inspects the process to determine whether the process priority is currently low.

In block 524, if the process priority is not low, then the resource priority is set to low, and in block 590, the method is done.

Returning to decision block 520, if the resource priority is already set to low, then in block 590, the method is done.

Returning to decision block 516, if the process priority is set to normal, then there may be a need to optimize the process priority.

In block 528, the agent determines the domain type and its resource requirements.

In block 532, the agent determines the current utilization level for the resources being used by the tab process.

In decision block 536, the agent determines whether the current utilization level is low.

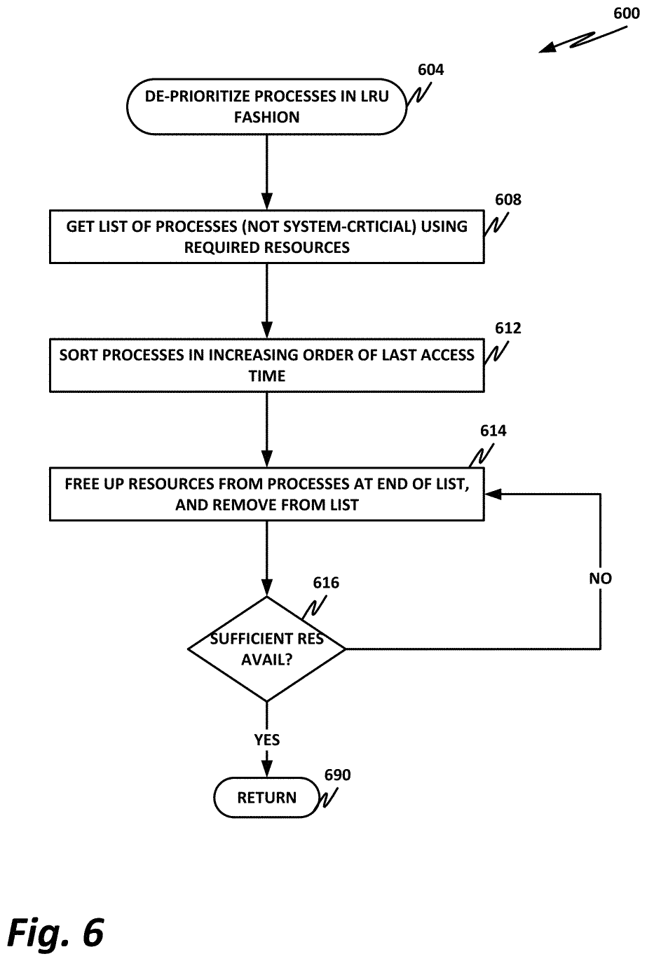

If current utilization is not low, then in block 540, the agent may identify processes with higher resource utilization, and deprioritize them in a least recently used (LRU) fashion, as illustrated in method 600 of FIG. 6.

Returning to decision block 536, if the current resource utilization is low, then in block 544, the agent may prioritize identified resource allocation for this process.

In block 548, the agent sets the current process priority to high.

In block 552, the agent sets the resource and process priority for the browser process as high.

In block 590, the method is done.

Certain aspects of method 500 will now be discussed in greater detail.

With respect to 504, the agent may initially get all browser process creation events and all domain name system (DNS) queries originating from the browser.

With respect to block 512, immediately after the process creation event, if the process was a tab process, the first domain query originating from the browser may be identified as the domain the user actually wishes to visit. Such domains may be referred to as “primary domains.” All other domain requests originating from the browser are treated as “secondary domains.” In some embodiments, these are also referred to as “associated domains,” but in this description, these domains will be referred to as secondary domains to avoid confusion of these domains with domains associated with or mapped to a URL by the browser optimizer agent.

For example, if the user visits www.theeconomictimes.com, that URL becomes the primary domain. All other subsequent domains, including advertisement domains, third-party news domains, and similar become secondary domains for purposes of this process.

In connection with method 500, top primary domains and their corresponding secondary domains may be profiled. A list of top primary domains and corresponding secondary domains may be created by profiling typical browser activity in a laboratory environment. These correlations can be provided in a central database, such as GTI by MCAFEE, LLC, or some other cloud resource. Once these correlations are made, the lab profile data can also be used along with a statistical method based on a time delta between two domain requests, and between a tab creation and domain request, to determine if the domain is a primary domain or a secondary domain.

For example, if (T_{D2}-T_{D1})<(TH)_{ASSOC}, then domain D₂ is a secondary domain. T_{D1} is the time of the first domain request, T_{D2} is the time of the second domain request, and the secondary threshold domain Dᵢ is the i^{th} domain request.

In connection with block 508, for every browser process creation event, it is determined whether the process is a tab process. This may be determined, for example, from command line parameters used to launch the process. If the domain query is for a primary domain, then the domain may be marked as a “boost candidate” (e.g., the “yes” branch from decision block 512). If the domain query is for a secondary domain and the process is not already a boost candidate, then the process may be marked as a subprocess (e.g., the “no” branch of decision block 508).

The agent may also identify a change in tab context. There are numerous ways to determine a change in tab context. For example, a change in tab context may be determined based on a change in the resource requirements of a tab (e.g., renderer) process. In another example, for Chromium-based browsers in particular, a change in tab process priority from “low” to “normal” may be used to identify a change. This is represented by the branch of blocks 516, 520, and 524 of method 500. Note that Chrome manages all of its processes and the process priorities internally. When a user switches between web applications (tabs), Chrome sets the process priority for the old tab to “low,” and that of the new tab to “normal.” Furthermore, processes corresponding to active background tasks (such as audio/video streaming, download, etc.) may also have their priorities set to “normal.”

Representing the yes branch from decision block 516, the agent may act accordingly for any boosting candidate if the current process priority is normal.

Corresponding to block 528, the agent determines the type of domain and its resource requirements. For example, YouTube.com and Netflix.com are streaming types of domains, and would require high network bandwidth and processor and/or rendering capability. Similarly, Agame.com and Zynga.com are gaming types of domains that would require GPU support along with high network bandwidth and rendering capability. Social network sites like Facebook.com and Instagram.com would require good rendering capability, high network bandwidth, and higher disk I/O capabilities.

In association with block 532, the agent may determine the current resource utilization level for resources required by the boosting candidate process. To determine the resource utilization level, in addition to real-time utilization level, the agent may use heuristics derived from the utilization levels collected by various products, such as agents installed on a variety of endpoints. This can include, for example, products by MCAFEE, LLC such as PC-Boost and Game-Boost. Heuristic data may be collected and aggregated in a cloud-based repository, where it can be accessed via many different agents.

In connection with decision block 536, if current utilization levels are low, then more resources may be allocated to the boosting candidate. This may be accomplished by deprioritizing other tasks, as illustrated in method 600 of FIG. 6.

On the other hand, if the current utilization levels are high, then the agent may identify processes that are consuming those resources. For example, the agent may determine the user relevance and system importance of those processes. If a process is not relevant to the user and not critical to the system (e.g., a process running in the background or running a longer-term task that is not user initiated, such as updates and scans), then those tasks may be deprioritized. For example, the agent may lower the resource priority for those processes, or even suspend those processes.

The agent may also create a profile of relevant processes for the user, based on the location and kind of network the user is connected to. This profile can contain a list of processes that are important for the user in the environment, and that should not be deprioritized. For example, in an “office” profile, a build process running in the background, or an update process triggered by information technology (IT) staff, may be important for the user and hence should not be deprioritized. In a “home” profile, certain security functions or home networking functions may not be deprioritized.

By way of an illustrative example, if a process corresponding to Agame.com (needing more network, rendering, and GPU resources) is the boosting candidate, then other processes may be identified that are currently utilizing network and GPU. The agent may then deprioritize the network and GPU priority for these processes in the LRU fashion, as illustrated in FIG. 6.

In connection with block 544, the agent may prioritize the identified resource allocation for the boosting candidate. For example, if a process corresponding to Agame.com was the boosting candidate, then a higher network priority may be set, a higher JavaScript rendering priority may be set, and a higher GPU priority may be set for that process.

Because most of the networking and I/O operations are performed using the main browser process, the resource priority for all identified resources may also be set high for the browser process, itself.

Furthermore, the process priority for the boosting candidate may also be set to high, to ensure that the process gets better execution time slices.

It should also be noted that, if the current process priority is high, then no further action may need to be taken. The process is already boosted.

As illustrated in the “no” branch from block 516, for any process that has its process priority set too low, if the resource priorities are high, then the corresponding resource priority should be set to low. This ensures that tab processes that are no longer in the foreground, or no longer relevant, are appropriately deprioritized and that resources are released for other relevant processes.

FIG. 6 is a flowchart of a method 600 for deprioritization of processes.

Starting with block 604, processes may be deprioritized in an LRU fashion.

In block 608, the agent may get a list of processes that are not system critical that are currently using the required resources.

In block 612, the agent may sort the processes in the increasing order of last accessed time.

In block 614, the agent may free up resources from processes that are at the end of the list and remove those processes from the list. In decision block 616, the agent checks to see whether sufficient resources are now available.

If sufficient resources have not been freed up, then control flows back to block 614, and the process repeats until sufficient resources have been freed up.

Returning to decision block 616, once sufficient resources have been freed up, those resources can be allocated to the boosted process, and in block 690, the method is done.

It should be noted that the operations illustrated for methods 500 of FIG. 5 and 600 of FIG. 6 are discussed in particular from the perspective of Chrome browsers. This is done because Chrome is a popular browser in the consumer segment. However, the teachings herein are not limited to the Chrome browser. For example, the method illustrated here would work for any browser based on the Chromium platform, or for any browser employing a “one process per tab” architecture.

The mechanism discussed for identifying tab processes that are relevant for the user from outside the browser platform (black box), and boosting/deboosting them as necessary, can also be scaled to other browser platforms adopting multi-process architecture with one process per instance of the web application.

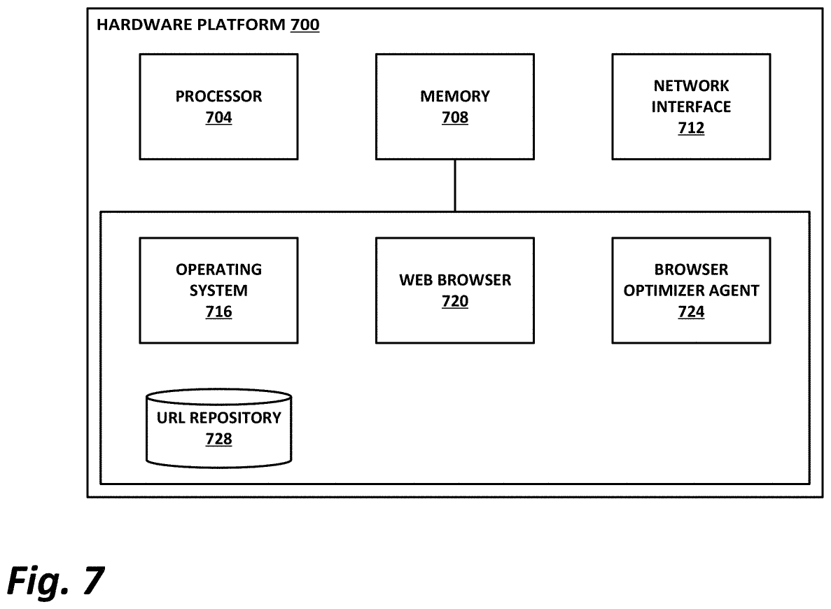

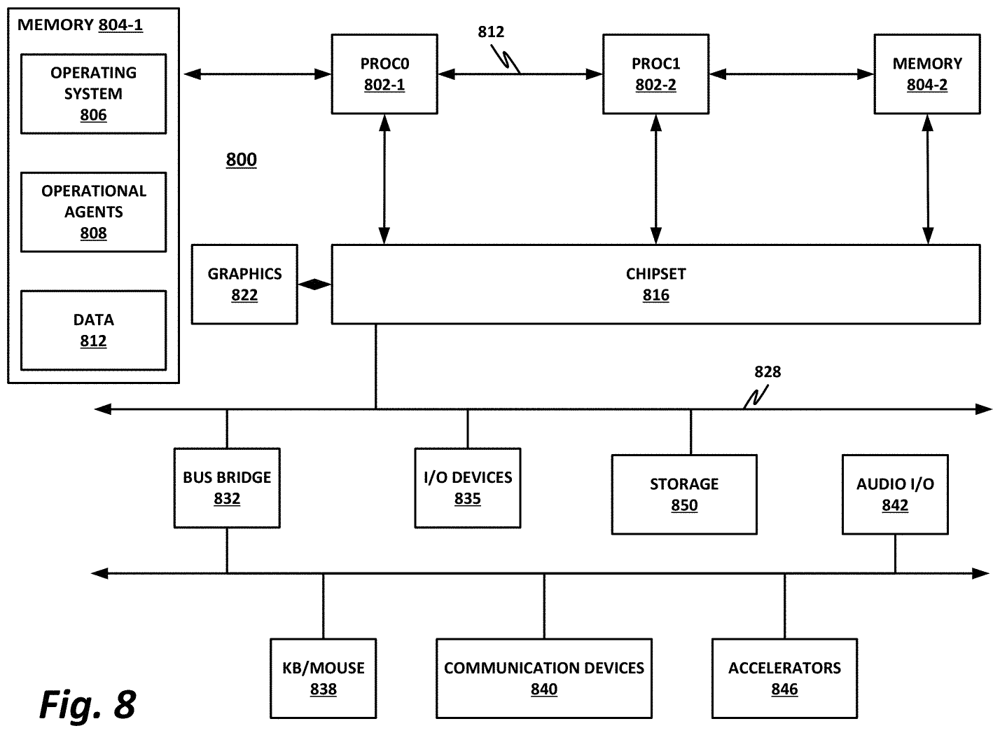

FIG. 7 is a block diagram illustrating selected elements of a hardware platform 700. For the purpose of simplicity, only selected elements are shown in connection with hardware platform 700. This is to illustrate in a focused manner certain teachings of the present specification. More detailed views of selected elements of a hardware platform are provided in FIGS. 8, 9, and 10.

In this example, hardware platform 700 includes a processor 704, a memory 708, and a network interface 712. Additional details on processors, memories, and network interfaces are provided in FIGS. 8, 9, and 10, and the details of those FIGURES are incorporated by reference into FIG. 7.

Within memory, hardware platform 700 operates a number of software modules or agents. These include operating system 716, web browser 720, and browser optimizer agent 724. There is also provided within memory 708 a URL repository 728.

Operating system 716 provides basic low-level services and drivers, including a privilege architecture.

Web browser 720 is a web browser that may include a multi-tab and multi-process architecture. Web browser 720 may manage its own resources, but as described above, web browser 720 generally manages resources in a conservative manner, so as not to interfere with other software agents running on operating system 716. Generally, web browser 720 does not have a detailed view of operating system 716, including its privilege architecture, while operating system 716 does not have a detailed view of the internal workings and needs of web browser 720.

Browser optimizer agent 724 is provided to bridge the gap between operating system 716 and web browser 720. For example, browser optimizer agent 724 may be configured to provide methods 500 of FIG. 5 and 600 of FIG. 6, in addition to other software methods. In providing these methods, browser optimizer agent 724 may access URL repository 728. For example, URL repository 728 may include a domain name or URL-based preferred resource scheme for certain processes running on web browser 720. Browser optimizer agent 724 can query URL repository 728 for a URL or domain name associated with a process running under web browser 720. URL repository 728 may include preferred resource allocations for processes associated with that domain name.

In some cases, URL repository 728 may be a local cache of a cloud-based URL repository, accessed via network interface 712.

FIG. 8 is a block diagram of a hardware platform 800. In at least some embodiments, hardware platform 800 may be configured or adapted to provide the method of resource management for web browser based applications, according to the teachings of the present specification.

Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Furthermore, in some embodiments, entire computing devices or platforms may be virtualized, on a single device, or in a data center where virtualization may span one or a plurality of devices. For example, in a “rackscale architecture” design, disaggregated computing resources may be virtualized into a single instance of a virtual device. In that case, all of the disaggregated resources that are used to build the virtual device may be considered part of hardware platform 800, even though they may be scattered across a data center, or even located in different data centers.

Hardware platform 800 is configured to provide a computing device. In various embodiments, a “computing device” may be or comprise, by way of nonlimiting example, a computer, workstation, server, mainframe, virtual machine (whether emulated or on a “bare-metal” hypervisor), network appliance, container, IoT device, high performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 800 is arranged in a point-to-point (PtP) configuration. This PtP configuration is popular for personal computer (PC) and server-type devices, although it is not so limited, and any other bus type may be used.

Hardware platform 800 is an example of a platform that may be used to implement embodiments of the teachings of this specification. For example, instructions could be stored in storage 850. Instructions could also be transmitted to the hardware platform in an ethereal form, such as via a network interface, or retrieved from another source via any suitable interconnect. Once received (from any source), the instructions may be loaded into memory 804, and may then be executed by one or more processor 802 to provide elements such as an operating system 806, operational agents 808, or data 812.

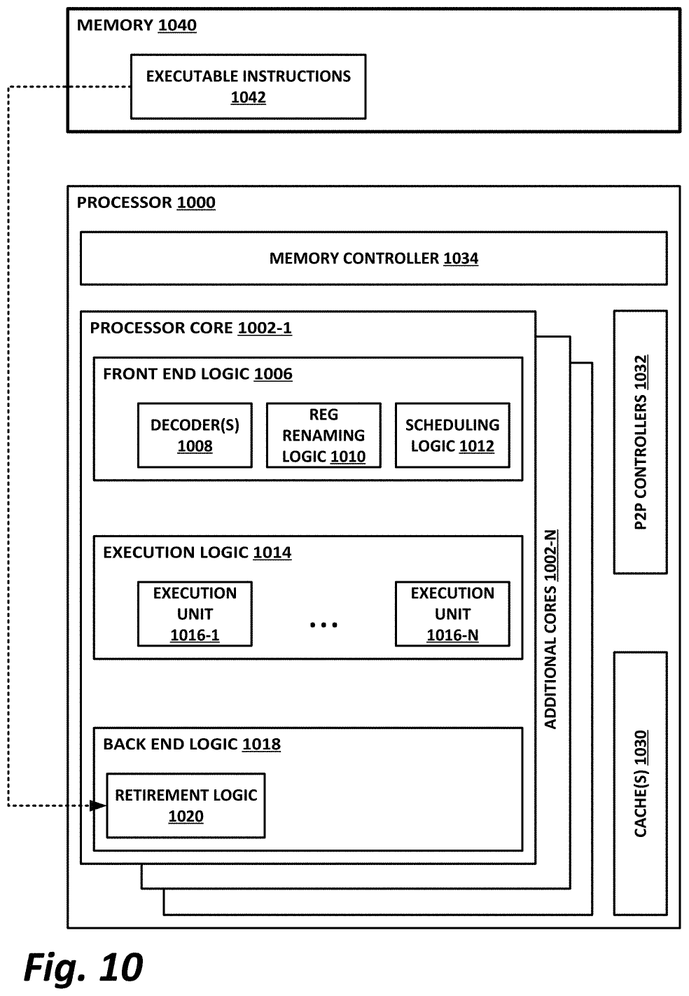

Hardware platform 800 may include several processors 802. For simplicity and clarity, only processors PROC0 802-1 and PROC1 802-2 are shown. Additional processors (such as 2, 4, 8, 16, 24, 32, 64, or 128 processors) may be provided as necessary, while in other embodiments, only one processor may be provided. Details of processors 802 are not illustrated in this FIGURE, but one embodiment is illustrated in FIG. 10. Processors may have any number of cores, such as 1, 2, 4, 8, 16, 24, 32, 64, or 128 cores.

Processors 802 may be any type of processor and may communicatively couple to chipset 816 via, for example, PtP interfaces. Chipset 816 may also exchange data with other elements, such as a high performance graphics adapter 822. In alternative embodiments, any or all of the PtP links illustrated in FIG. 8 could be implemented as any type of bus, or other configuration rather than a PtP link. In various embodiments, chipset 816 may reside on the same die or package as a processor 802 or on one or more different dies or packages. Each chipset may support any suitable number of processors 802. A chipset 816 (which may be a chipset, uncore, Northbridge, Southbridge, or other suitable logic and circuitry) may also include one or more controllers to couple other components to one or more CPUs.

Two memories, 804-1 and 804-2 are shown, connected to PROC0 802-1 and PROC1 802-2, respectively. As an example, each processor is shown connected to its memory in a direct memory access (DMA) configuration, though other memory architectures are possible, including ones in which memory 804 communicates with processor 810 via a bus. For example, some memories may be connected via a system bus, or in a data center, memory may be accessible in a remote DMA (RDMA) configuration.

Memory 804 may include any form of volatile or non-volatile memory including, without limitation, magnetic media (e.g., one or more tape drives), optical media, flash, random access memory (RAM), double data rate RAM (DDR RAM) non-volatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory region, read-only memory (ROM), flash memory, removable media, tape drive, cloud storage, or any other suitable local or remote memory component or components. Memory 804 may be used for short, medium, and/or long-term storage. Memory 804 may store any suitable data or information utilized by platform logic. In some embodiments, memory 804 may also comprise storage for instructions that may be executed by the cores of processors 802 or other processing elements (e.g., logic resident on chipsets 816) to provide functionality.

In certain embodiments, memory 804 may comprise a relatively low-latency volatile main memory, while storage 850 may comprise a relatively higher-latency non-volatile memory. However, memory 804 and storage 850 need not be physically separate devices, and in some examples may represent simply a logical separation of function (if there is any separation at all). It should also be noted that although DMA is disclosed by way of nonlimiting example, DMA is not the only protocol consistent with this specification, and that other memory architectures are available.

Certain computing devices provide main memory 804 and storage 850, for example, in a single physical memory device, and in other cases, memory 804 and/or storage 850 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Graphics adapter 822 may be configured to provide a human-readable visual output, such as a command line interface (CLI) or graphical desktop such as Microsoft Windows, Apple OSX desktop, or a UNIX/Linux X Window System-based desktop. Graphics adapter 822 may provide output in any suitable format, such as a coaxial output, composite video, component video, video graphics array (VGA), or digital outputs such as digital visual interface (DVI), FPDLink, DisplayPort, or high definition multimedia interface (HDMI), by way of nonlimiting example. In some examples, graphics adapter 822 may include a hardware graphics card, which may have its own memory and its own GPU.

Chipset 816 may be in communication with a bus 828 via an interface circuit. Bus 828 may have one or more devices that communicate over it, such as a bus bridge 832, I/O devices 835, accelerators 846, communication devices 840, and a keyboard and/or mouse 838, by way of nonlimiting example. In general terms, the elements of hardware platform 800 may be coupled together in any suitable manner. For example, a bus may couple any of the components together. A bus may include any known interconnect, such as a multi-drop bus, a mesh interconnect, a fabric, a ring interconnect, a round-robin protocol, a PtP interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 840 can broadly include any communication not covered by a network interface and the various I/O devices described herein. This may include, for example, various universal serial bus (USB), FireWire, Lightning, or other serial or parallel devices that provide communications.

I/O Devices 835 may be configured to interface with any auxiliary device that connects to hardware platform 800 but that is not necessarily a part of the core architecture of hardware platform 800. A peripheral may be operable to provide extended functionality to hardware platform 800, and may or may not be wholly dependent on hardware platform 800. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage, by way of nonlimiting example.

In one example, audio I/O 842 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth, or Wi-Fi audio, by way of nonlimiting example. Audio input may also be provided via similar interfaces, in an analog or digital form.

Bus bridge 832 may be in communication with other devices such as a keyboard/mouse 838 (or other input devices such as a touch screen, trackball, etc.), communication devices 840 (such as modems, network interface devices, peripheral interfaces such as PCI or PCIe, or other types of communication devices that may communicate through a network), audio I/O 842, a data storage device 844, and/or accelerators 846. In alternative embodiments, any portions of the bus architectures could be implemented with one or more PtP links.

Operating system 806 may be, for example, Microsoft Windows, Linux, UNIX, Mac OS X, iOS, MS-DOS, or an embedded or real-time operating system (including embedded or real-time flavors of the foregoing). In some embodiments, a hardware platform 800 may function as a host platform for one or more guest systems that invoke application (e.g., operational agents 808).

Operational agents 808 may include one or more computing engines that may include one or more non-transitory computer-readable mediums having stored thereon executable instructions operable to instruct a processor to provide operational functions. At an appropriate time, such as upon booting hardware platform 800 or upon a command from operating system 806 or a user or security administrator, processor 802 may retrieve a copy of the operational agent (or software portions thereof) from storage 850 and load it into memory 804. Processor 810 may then iteratively execute the instructions of operational agents 808 to provide the desired methods or functions.

As used throughout this specification, an “engine” includes any combination of one or more logic elements, of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of nonlimiting example.

Where elements of an engine are embodied in software, computer program instructions may be implemented in programming languages, such as an object code, an assembly language, or a high level language such as OpenCL, FORTRAN, C, C++, JAVA, or HTML. These may be used with any compatible operating systems or operating environments. Hardware elements may be designed manually, or with a hardware description language such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

A network interface may be provided to communicatively couple hardware platform 800 to a wired or wireless network or fabric. A “network,” as used throughout this specification, may include any communicative platform operable to exchange data or information within or between computing devices, including, by way of nonlimiting example, a local network, a switching fabric, an ad-hoc local network, Ethernet (e.g., as defined by the IEEE 802.3 standard), Fibre Channel, InfiniBand, Wi-Fi, or other suitable standard. Intel Omni-Path Architecture (OPA), TrueScale™, Ultra Path Interconnect (UPI) (formerly called QPI or KTI), FibreChannel, Ethernet, FibreChannel over Ethernet (FCoE), InfiniBand, PCI, PCIe, fiber optics, millimeter wave guide, an internet architecture, a packet data network (PDN) offering a communications interface or exchange between any two nodes in a system, a local area network (LAN), metropolitan area network (MAN), wide area network (WAN), wireless local area network (WLAN), virtual private network (VPN), intranet, plain old telephone system (POTS), or any other appropriate architecture or system that facilitates communications in a network or telephonic environment, either with or without human interaction or intervention. A network interface may include one or more physical ports that may couple to a cable (e.g., an Ethernet cable, other cable, or waveguide).

In some cases, some or all of the components of hardware platform 800 may be virtualized, in particular the processor(s) and memory. For example, a virtualized environment may run on OS 806, or OS 806 could be replaced with a hypervisor or virtual machine manager. In this configuration, a virtual machine running on hardware platform 800 may virtualize workloads. A virtual machine in this configuration may perform essentially all of the functions of a physical hardware platform.

In a general sense, any suitably-configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

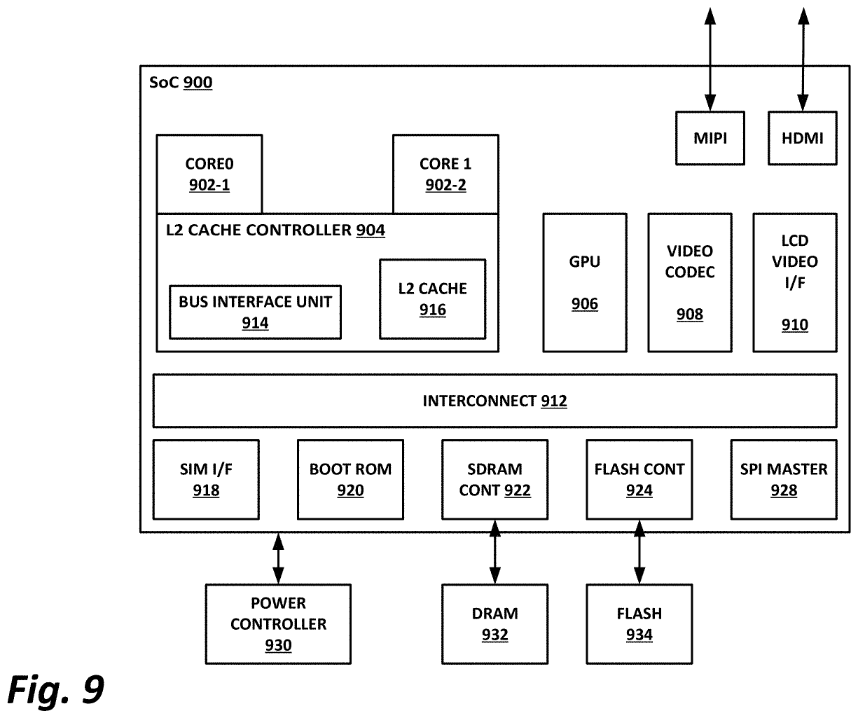

Various components of the system depicted in FIG. 8 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments. An example of such an embodiment is provided in FIG. 9. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), FPGAs, and other semiconductor chips.

FIG. 9 is a block illustrating selected elements of an example SoC 900. In at least some embodiments, SoC 900 may be configured or adapted to provide the method of resource management for web browser based applications, according to the teachings of the present specification.

At least some of the teachings of the present specification may be embodied on an SoC 900, or may be paired with an SoC 900. SoC 900 may include, or may be paired with, an advanced reduced instruction set computer machine (ARM) component. For example, SoC 900 may include or be paired with any ARM core, such as A-9, A-15, or similar. This architecture represents a hardware platform that may be useful in devices such as tablets and smartphones, by way of illustrative example, including Android phones or tablets, iPhone (of any version), iPad, Google Nexus, Microsoft Surface. SoC 900 could also be integrated into, for example, a PC, server, video processing components, laptop computer, notebook computer, netbook, or touch-enabled device.

As with hardware platform 800 above, SoC 900 may include multiple cores 902-1 and 902-2. In this illustrative example, SoC 900 also includes an L2 cache control 904, a GPU 906, a video codec 908, a liquid crystal display (LCD) I/F 910 and an interconnect 912. L2 cache control 904 can include a bus interface unit 914, a L2 cache 916. Liquid crystal display (LCD) I/F 910 may be associated with mobile industry processor interface (MIPI)/HDMI links that couple to an LCD.

SoC 900 may also include a subscriber identity module (SIM) I/F 918, a boot ROM 920, a synchronous dynamic random access memory (SDRAM) controller 922, a flash controller 924, a serial peripheral interface (SPI) master 928, a suitable power control 930, a dynamic RAM (DRAM) 932, and flash 934. In addition, one or more embodiments include one or more communication capabilities, interfaces, and features such as instances of Bluetooth™ 936, a 3G modem 938, a global positioning system (GPS) 940, and an 802.11 Wi-Fi 942.

Designers of integrated circuits such as SoC 900 (or other integrated circuits) may use intellectual property (IP) blocks to simplify system design. An IP block is a modular, self-contained hardware block that can be easily integrated into the design. Because the IP block is modular and self-contained, the integrated circuit (IC) designer need only “drop in” the IP block to use the functionality of the IP block. The system designer can then make the appropriate connections to inputs and outputs.

IP blocks are often “black boxes.” In other words, the system integrator using the IP block may not know, and need not know, the specific implementation details of the IP block. Indeed, IP blocks may be provided as proprietary third-party units, with no insight into the design of the IP block by the system integrator.

For example, a system integrator designing an SoC for a smart phone may use IP blocks in addition to the processor core, such as a memory controller, a non-volatile memory (NVM) controller, Wi-Fi, Bluetooth, GPS, a fourth or fifth-generation network (4G or 5G), an audio processor, a video processor, an image processor, a graphics engine, a GPU engine, a security controller, and many other IP blocks. In many cases, each of these IP blocks has its own embedded microcontroller.

FIG. 10 is a block diagram illustrating selected elements of a processor 1000. In at least some embodiments, processor 1000 may be configured or adapted to provide the method of resource management for web browser based applications, according to the teachings of the present specification.

In various examples, and throughout this specification and the appended claims, a “processor” may include any combination of logic elements operable to execute instructions, whether loaded from memory, or implemented directly in hardware, including, by way of nonlimiting example, a microprocessor, microcontroller, CPU, advanced RISC (reduced instruction set computing) machine (ARM), digital signal processor (DSP), FPGA, GPU, programmable logic array, ASIC, or virtual machine processor. In certain architectures, a multi-core processor may be provided, having for example, 2, 4, 8, 12, 16, 24, 32, 64, or 128 cores. In some embodiments, one or more co-processors or accelerators (hardware or software) may also be provided for specialized or support functions. In general, processor 1000 may include any number of processing elements, which may be symmetrical or asymmetrical.

Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. A physical CPU may include any suitable number of cores. In various embodiments, cores may include one or more out-of-order processor cores or one or more in-order processor cores. However, cores may be individually selected from any type of core, such as a native core, a software managed core, a core adapted to execute a native instruction set architecture (ISA), a core adapted to execute a translated ISA, a co-designed core, or other known core. In a heterogeneous core environment (i.e. asymmetric cores), some form of translation, such as binary translation, may be utilized to schedule or execute code on one or both cores.

Processor 1000 includes one or more processor cores 1002, including core 1002-1-1002-N. Cores 1002 may be, as appropriate, single-thread cores or multi-thread cores. In multithreaded cores, more than one hardware thread may be provided at a time, and the core may therefore provide more than one logical core per physical core. The cores may be configured to execute instruction code. Each processor 1000 may include at least one shared cache 1030, which may be treated logically as part of memory 1040. Memory 1040 may include executable instructions 1042, as illustrated. Caches 1030 may be filled according to known caching techniques, and may store instructions and/or data that may be used by one or more components of processor 1000.

Processor 1000 may include an integrated memory controller (MC) 1034, to communicate with memory 1040. Memory controller 1034 may include logic and circuitry to interface with memory 1040, and may also include a cache controller to handle filling and evicting instructions and data to and from cache 1030.

By way of example, each core 1002 may include front-end logic 1006, execution logic 1014, and backend logic 1018.

In the illustrated embodiment, front-end logic 1006 includes an instruction decoder or decoders 1008, register renaming logic 1010, and scheduling logic 1012. Decoder 1008 may decode instructions received. Register renaming logic 1010 may provide register renaming, for example to facilitate pipelining. Scheduling logic 1012 may schedule instruction execution, and may provide out-of-order (000) execution. Front-end logic 1006 may fetch incoming instructions, perform various processing (e.g., caching, decoding, branch predicting, etc.), and pass instructions to execution logic 1014.

Execution logic 1014 includes one or more execution units 1016-1-1016-N. Execution units 1016 may include hardware instructions and microcode to carry out the provided instructions.

Backend logic 1018 includes retirement logic 1020. Core 1002 may provide for speculative execution of instructions, branch prediction, and similar. Retirement logic 1020 may be configured to determine which predicted instructions were actually needed by the program flow.

Processor 1000 may also include a PtP controller 1032, which enables connection to an uncore, chipset, Northbridge, Southbridge, or bus, by way of example.

The foregoing outlines features of several embodiments so that those skilled in the art may better understand various aspects of the present disclosure. The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a non-volatile memory. Thus, for example, an “engine” as described above could include instructions encoded within a memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, non-transitory computer-readable storage media that contain stored instructions. These instructions, in conjunction with the hardware platform (including a processor) on which they are stored may constitute a computing apparatus.

In other embodiments, a computing apparatus may also read on an operating device. For example, in this configuration, the “memory” could include a volatile or run-time memory (e.g., RAM), where instructions have already been loaded. These instructions, when fetched by the processor and executed, may provide methods or procedures as described herein.

In yet another embodiment, there may be one or more tangible, non-transitory computer-readable storage media having stored thereon executable instructions that, when executed, cause a hardware platform or other computing system, to carry out a method or procedure. For example, the instructions could be executable object code, including software instructions executable by a processor. The one or more tangible, non-transitory computer-readable storage media could include, by way of illustrative and nonlimiting example, a magnetic media (e.g., hard drive), a flash memory, a ROM, optical media (e.g., CD, DVD, Blu-Ray), non-volatile RAM (NVRAM), NVM (e.g., Intel 3D Xpoint), or other non-transitory memory.

There are also provided herein certain methods, illustrated for example in flow charts and/or signal flow diagrams. The order or operations disclosed in these methods discloses one illustrative ordering that may be used in some embodiments, but this ordering is no intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a nonlimiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected element. Such elements are selected to illustrate specific information to facilitate the description. The inclusion of an element in the FIGURES is not intended to imply that the element must appear in the invention, as claimed, and the exclusion of certain elements from the FIGURES is not intended to imply that the element is to be excluded from the invention as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

In order to aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

### EXAMPLE IMPLEMENTATIONS

There is disclosed in one example, a computing apparatus, comprising: a hardware platform comprising a processor and a memory; an operating system comprising a priority architecture; a multi-process web browser; and a browser optimizer agent comprising instructions encoded within the memory to instruct the processor to: inspect a process of the web browser; determine from the inspection that resource utilization for the process can be improved, and adjust resource priority via the operating system to improve resource utilization for the process.

There is further disclosed an example computing apparatus, wherein determining that resource utilization can be improved comprises identifying the process as a boost candidate.

There is further disclosed an example computing apparatus, wherein the instructions are further to determine that the web browser has set a low priority for the process, and to identify the process as not a boost candidate.

There is further disclosed an example computing apparatus, wherein determining that resource utilization can be improved comprises determining that the web browser has assigned the process normal priority.

There is further disclosed an example computing apparatus, wherein determining that resource utilization can be improved comprises querying a URL store for a URL associated with the process, and receiving preferred resource data for the URL.

There is further disclosed an example computing apparatus, wherein the URL store is a cloud-based URL store.

There is further disclosed an example computing apparatus, wherein the instructions are further to identify the URL as a primary URL for the process.

There is further disclosed an example computing apparatus, wherein the instructions are further to identify the URL as a secondary URL, and to mark the process as not a candidate for boosting.

There is further disclosed an example computing apparatus, wherein determining that resource utilization can be improved comprises determining that the process is a tab process of the browser.

There is further disclosed an example computing apparatus, wherein determining that the process is a tab process comprises inspecting a command line that launched the process.

There is further disclosed an example computing apparatus, wherein the instructions are further to identify and respond to a context switch for the process.

There is further disclosed an example computing apparatus, wherein the context switch comprises a tab associated with the process losing focus.

There is further disclosed an example computing apparatus, wherein the instructions are further to identify the process as belonging to a class of processes not to be deprivileged after losing focus.

There is further disclosed an example computing apparatus, wherein the class includes downloads and multimedia processes.

There is further disclosed an example computing apparatus, wherein improving resource utilization comprises deprivileging other processes.

There is further disclosed an example computing apparatus, wherein the other processes include browser processes that have lost focus.

There is further disclosed an example computing apparatus, wherein the instructions are further to query a system profile for a list or class of non-browser processes that are not to be deprivileged.

There is further disclosed an example computing apparatus, wherein resource utilization includes network bandwidth, CPU, or GPU utilization.

There is also disclosed an example of one or more tangible, non-transitory computer-readable storage media having stored thereon executable instructions to: enumerate, on a host system, tab processes of a multi-process web browser; identify at least one candidate process for boosting, the candidate process having associated therewith a domain name; query a domain name repository for preferred resources for the domain name; determine that the host system has an available resource to boost the candidate process; and assign to the candidate process an increased share of the available resource.

There is further disclosed an example of one or more tangible, non-transitory computer-readable media, wherein the instructions are further to determine that the web browser has set a low priority for the candidate process, and to identify the candidate process as not a boost candidate.

There is further disclosed an example of one or more tangible, non-transitory computer-readable media, wherein identifying the candidate process for boosting comprises determining that the web browser has assigned the candidate process normal priority.

There is further disclosed an example of one or more tangible, non-transitory computer-readable media, wherein querying the domain repository comprises receiving preferred resource data for the domain name.

There is further disclosed an example of one or more tangible, non-transitory computer-readable media, wherein the domain repository is a cloud-based domain repository.

There is further disclosed an example of one or more tangible, non-transitory computer-readable media, wherein identifying the candidate process for boosting comprises identifying the domain name as a primary domain name for the candidate process.

There is further disclosed an example of one or more tangible, non-transitory computer-readable media, wherein the instructions are further to identify the domain name as a secondary domain name, and to mark the candidate process as not a candidate for boosting.

There is further disclosed an example of one or more tangible, non-transitory computer-readable media, wherein enumerating tab processes comprises determining that the processes are tab process of the browser.

There is further disclosed an example of one or more tangible, non-transitory computer-readable media, wherein determining that a process is a tab process of the browser comprises inspecting a command line that launched the process.

There is further disclosed an example of one or more tangible, non-transitory computer-readable media, wherein the instructions are further to identify and respond to a context switch for the candidate process.

There is further disclosed an example of one or more tangible, non-transitory computer-readable media, wherein the context switch comprises a tab associated with the candidate process losing focus.

There is further disclosed an example of one or more tangible, non-transitory computer-readable media, wherein the instructions are further to identify the candidate process as belonging to a class of processes not to be deprivileged after losing focus.

There is further disclosed an example of one or more tangible, non-transitory computer-readable media, wherein the class includes downloads and multimedia processes.

There is further disclosed an example of one or more tangible, non-transitory computer-readable media, wherein assigning to the candidate process an increased share of the available resource comprises deprivileging other processes.

There is further disclosed an example of one or more tangible, non-transitory computer-readable media, wherein the other processes include browser processes that have lost focus.

There is further disclosed an example of one or more tangible, non-transitory computer-readable media, wherein the instructions are further to query a system profile for a list or class of non-browser processes that are not to be deprivileged.

There is also disclosed an example computer-implemented method of providing operating system (OS)-integrated management of resources for a web browser, comprising: enumerating open processes for the web browser; identifying one or more open processes as belonging to one or more open tabs or windows of the web browser; marking a process belonging to an open tab or window as a candidate for resource boosting; identifying a resource for the candidate according to a URL accessed by the candidate; and interoperating with the OS to increase the candidate's access to the resource.

There is further disclosed an example method, further comprising determining that the web browser has set a low priority for the candidate process, and identifying the candidate process as not a boosting candidate.

There is further disclosed an example method, wherein identifying the candidate process for resource boosting comprises determining that the web browser has assigned the candidate process normal priority.

There is further disclosed an example method, further comprising querying a URL repository for preferred resource data for the URL.

There is further disclosed an example method, wherein the URL repository is a cloud-based URL repository.

There is further disclosed an example method, wherein identifying the candidate process for resource boosting comprises identifying the URL as a primary URL for the candidate process.

There is further disclosed an example method, further comprising identifying the URL as a secondary URL for the candidate process, and marking the candidate process as not a candidate for resource boosting.

There is further disclosed an example method, wherein identifying one or more open processes as belonging to one or more open tabs or windows of the web browser comprises inspecting a command line that launched the process.

There is further disclosed an example method, further comprising identifying and responding to a context switch for the candidate process.

There is further disclosed an example method, wherein the context switch comprises a tab associated with the candidate process losing focus.

There is further disclosed an example method, further comprising identifying the candidate process as belonging to a class of processes not to be deprivileged after losing focus.

There is further disclosed an example method, wherein the class includes downloads and multimedia processes.

There is further disclosed an example method, wherein increasing the candidate process's access to the resource comprises deprivileging other processes.

There is further disclosed an example method, wherein the other processes include browser processes that have lost focus.

There is further disclosed an example method, further comprising querying a system profile for a list or class of non-browser processes that are not to be deprivileged.

There is further disclosed an example apparatus comprising means for performing the method of a number of the above examples.

There is further disclosed an example apparatus, wherein the means for performing the method comprise a processor and a memory.

There is further disclosed an example apparatus, wherein the memory comprises machine-readable instructions that, when executed, cause the apparatus to perform the method of a number of the above examples.

There is further disclosed an example apparatus, wherein the apparatus is a computing system.

There is further disclosed an example of at least one computer-readable medium comprising instructions that, when executed, implement a method or realize an apparatus as illustrated in a number of the above examples.

What is claimed is:

1. A computing apparatus, comprising:
a hardware platform comprising a processor and a memory;
an operating system comprising a priority architecture;
a multi-process web browser; and
a browser optimizer agent comprising instructions encoded within the memory to instruct the processor to:
inspect a process of the web browser;
determine from the inspection that resource utilization for the process can be improved, and
adjust resource priority via the operating system to improve resource utilization for the process.

2. The computing apparatus of claim 1, wherein determining that resource utilization can be improved comprises identifying the process as a boost candidate.

3. The computing apparatus of claim 1, wherein the instructions are further to determine that the web browser has set a low priority for the process, and to identify the process as not a boost candidate.

4. The computing apparatus of claim 1, wherein determining that resource utilization can be improved comprises determining that the web browser has assigned the process normal priority.

5. The computing apparatus of claim 1, wherein determining that resource utilization can be improved comprises querying a URL store for a URL associated with the process, and receiving preferred resource data for the URL.

6. The computing apparatus of claim 5, wherein the URL store is a cloud-based URL store.

7. The computing apparatus of claim 5, wherein the instructions are further to identify the URL as a primary URL for the process.

8. The computing apparatus of claim 5, wherein the instructions are further to identify the URL as a secondary URL, and to mark the process as not a candidate for boosting.

9. The computing apparatus of claim 1, wherein determining that resource utilization can be improved comprises determining that the process is a tab process of the browser.

10. The computing apparatus of claim 9, wherein determining that the process is a tab process comprises inspecting a command line that launched the process.

11. The computing apparatus of claim 1, wherein the instructions are further to identify and respond to a context switch for the process.

12. The computing apparatus of claim 11, wherein the context switch comprises a tab associated with the process losing focus.

13. One or more tangible, non-transitory computer-readable storage media having stored thereon executable instructions to:
enumerate, on a host system, tab processes of a multi-process web browser;
identify at least one candidate process for boosting, the candidate process having associated therewith a domain name;
query a domain name repository for preferred resources for the domain name;
determine that the host system has an available resource to boost the candidate process; and
assign to the candidate process an increased share of the available resource.

14. The one or more tangible, non-transitory computer-readable media of claim 13, wherein the instructions are further to identify the candidate process as belonging to a class of processes not to be deprivileged after losing focus.

15. The one or more tangible, non-transitory computer-readable media of claim 14, wherein the class includes downloads and multimedia processes.

16. The one or more tangible, non-transitory computer-readable media of claim 13, wherein assigning to the candidate process an increased share of the available resource comprises deprivileging other processes.

17. The one or more tangible, non-transitory computer-readable media of claim 16, wherein the other processes include browser processes that have lost focus.

18. The one or more tangible, non-transitory computer-readable media of claim 13, wherein the instructions are further to query a system profile for a list or class of non-browser processes that are not to be deprivileged.

19. A computer-implemented method of providing operating system (OS)-integrated management of resources for a web browser, comprising:
enumerating open processes for the web browser;
identifying one or more open processes as belonging to one or more open tabs or windows of the web browser;
marking a process belonging to an open tab or window as a candidate for resource boosting;
identifying a resource for the candidate according to a URL accessed by the candidate; and
interoperating with the OS to increase the candidate's access to the resource.

20. The method of claim 19, further comprising querying a URL repository for preferred resource data for the URL.
